(19) United States
(12) Patent Application Publication
(10) Pub. No.: US 2017/0353471 A1
(43) Pub. Date: Dec. 7, 2017

(54) Subscriber Identification Module and Application Executable on a Subscriber Identification Module

(71) Applicant: Giesecke+Devrient Mobile Security GmbH, München (DE)

(72) Inventors: Claus JARNIK, Windach (DE); Monika ECKARDT, Mammendorf (DE)

(21) Appl. No.: 15/542,561

(22) PCT Filed: Jan. 5, 2016
(86) PCT No.: PCT/EP2016/000013

§ 371 Date: Jul. 10, 2017

(30) Foreign Application Priority Data
Jan. 8, 2015 (DE) 10 2015 000 224.4

(51) Int. Cl. H04L 29/06; H04L 29/08; H04W 4/00; H04W 12/08; H04W 8/24; H04W 12/02

(52) U.S. Cl. CPC H04L 63/102; H04W 12/08; H04W 8/245; H04L 67/306; H04W 4/001; H04L 63/0428; H04W 12/02

(57) ABSTRACT

A subscriber identity module for employment in a mobile device has a processor, a storage as well as a location determining device. The location determining device is adapted to determine a location of the subscriber identity module. The subscriber identity module makes a plurality of functions available.

### TECHNICAL FIELD

The present invention relates to a subscriber identity module for employment in a mobile device, such as a mobile telephone, a wearable and/or a tablet PC as well as an application executable on a subscriber identity module.

### PRIOR ART

From EP 1 106 025 a method is known for providing intelligent network support for a mobile subscriber. According to the method, a mobile device, in particular a mobile telephone, sends a signal message from the SIM card to an intermediate unit, which interacts with a service control device of the Home Public Land Mobile Network (HPLMN). As a response to the message, a message is sent back to the SIM card, wherein the message contains INAP (Intelligently Network Application Part), CORBA, RMI, HTTP or XML messages.

Further is known in the prior art that SIM cards are firmly installed in mobile units (eUICC; embedded Universal Integrated Circuit Card) or are supplied as separate units in different form factors from 1FF to 4FF.

Further is known that SIM cards are supplied to different countries and can in different countries be used—if applicable at roaming conditions, i.e. a modified fee structure—for handling telephone calls, data transfers etc.

In dependence on which country SIM cards are supplied to, there are different requirements for the functions which a SIM card may make available. These requirements are defined on the one hand by the local Mobile Network Operators (MNOs) and on the other hand by government agencies. The functions can be, for example, different safety requirement profiles of encryption algorithms or crypto-algorithms.

### STATEMENT OF THE INVENTION

The invention is based on the object of providing a subscriber identity module for employment in a mobile device as well as an application executable on a subscriber identity module, which solve the known problems from the prior art and are further suitable for the purpose of optimizing the safety and adaptability of subscriber identity modules in different markets.

This object is achieved by the subject matter of the independent claims. Preferred embodiments can be found in the dependent claims.

The invention is based on the idea that the subscriber identity module and/or an application on the subscriber identity module can define a functionality range of the subscriber identity module with consideration of a determined location.

Accordingly, a subscriber identity module for employment in a mobile device comprises a processor, a storage which has a communication connection with the processor, a location determining device which is adapted for the purpose of determining a location of the subscriber identity module, wherein the subscriber identity module is adapted for the purpose of making a plurality of functions available, wherein the subscriber identity module makes at least a part of the functions available in a restricted manner and/or not at all in dependence on the determined location.

With the subscriber identity module according to the invention it is especially advantageously possible to manufacture identical or almost entirely identical subscriber identity modules and to make the functional range or the functions provided by the subscriber identity module available in its entirety, in a restricted manner or not at all in dependence on the location in which the subscriber identity modules are used or which the subscriber identity modules are supplied to. Consequently, it is possible to supply subscriber identity modules with full functional range, i.e. with all functions, worldwide and the subscriber identity module thereupon determines which functions it may make available with the help of the location in which it is used. There are provisions which do not permit a manufacturer to make certain functions of a subscriber identity module available in certain countries. With the subscriber identity module according to the invention, this fact can be taken into account especially advantageously.

According to one embodiment, the storage is divided into a volatile storage area (Random Access Memory; RAM) and a non-volatile storage area (Read Only Memory; ROM, EEPROM). In this manner an efficient storage architecture is guaranteed.

According to a further particularly preferred embodiment, the location determining device is adapted for the purpose of determining the location with the help of a mobile radio cell which the subscriber identity module is registered with or which the subscriber identity module (which is arranged in a mobile device) is connected to. By exploiting the mobile radio cell which the subscriber identity module is registered with, it is especially advantageously possible to quickly determine the location of the subscriber identity module.

Alternatively, the location determining device for determining the location is able to employ a position detection module, wherein the position detection module can be integrated into the mobile device and/or the subscriber identity module. The position detection module can be a GPS position detection module and/or a GLONASS position detection module. By means of such position detection module, it is possible to capture the position of a subscriber identity module particularly quickly and precisely.

According to a further embodiment, the location comprises at least one information item as to which country the subscriber identity module is located in. In this manner it is possible to very quickly find out where the subscriber identity module is located, in particular which country the subscriber identity module is located in.

The subscriber identity module can be a SIM card, a UICC and/or an eUICC (embedded Universal Integrated Circuit Card).

The options available in dependence on the determined location are stored in a whitelist in the storage of the subscriber identity module according to a preferred embodiment. With the help of the whitelist, it can be determined which functions are permissible in the country. These functions are thereupon made available and the remaining functions are advantageously available only in a restricted manner.

Alternatively, according to a further embodiment, the functions not available in the determined location can be stored in a blacklist. Consequently, the subscriber identity module advantageously releases all functions except for the functions which are stored in the blacklist.

According to a particularly preferred embodiment, the function is a functional range of an encryption algorithm. In other words, the function defines to what extent an encryption takes place, i.e. how strong the encrypting is. The background is that in some countries only an encryption with a low strength is permissible. Consequently, the correct or permissible encryption degree can be selected in dependence on the location of the subscriber identity module.

According to a further embodiment, the subscriber identity module makes at least a part of the functions available in a restricted manner or not at all, in dependence on the mobile network operator (Mobile Network Operator; MNO) which the subscriber identity module is connected to. Accordingly, it is possible especially advantageously to establish the range of functions not only in dependence on the location the subscriber identity module is located at, but also in dependence on the mobile network operator the subscriber identity module is connected to.

Further, the advantages of the invention are also apparent in an application executable on a subscriber identity module, which is adapted to make available, in dependence on the determined location, at least a part of the functions in a restricted manner or not at all, wherein the application is adapted to determine the location of the subscriber identity module while employing a location determining device.

The advantages as explained above in detail also apply to the application executable on the subscriber identity module. Further, all features which were specified above with reference to the subscriber identity module can also be executed advantageously in combination with the application executed on the subscriber identity module.

### BRIEF DESCRIPTION OF THE DRAWING

FIG. 1 shows a schematic view of a mobile device in which a subscriber identity module is arranged, wherein the subscriber identity module is additionally represented in enlarged form in FIG. 1.

### DETAILED DESCRIPTION OF PREFERRED EMBODIMENTS OF THE INVENTION

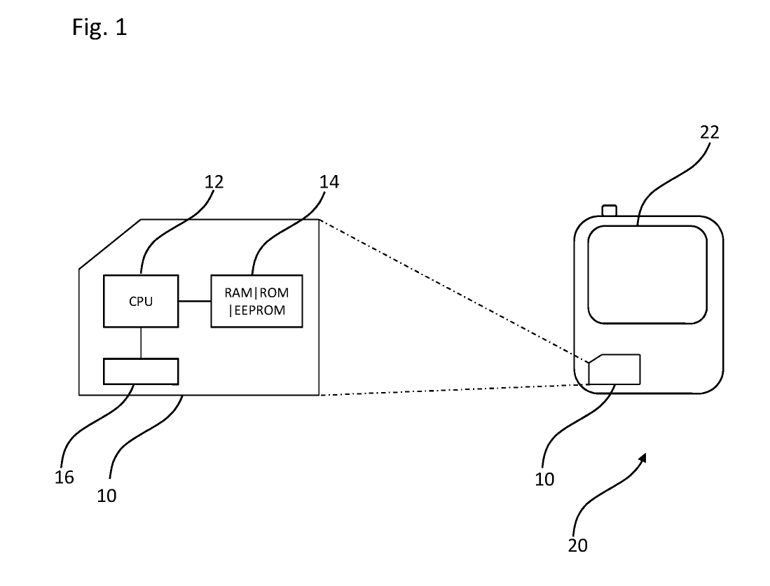

A subscriber identity module according to the invention as well as an application executable on a subscriber identity module according to the invention are described hereinafter with reference to the embodiment shown by way of example in FIG. 1.

FIG. 1 shows a mobile device 20 which is furnished with a display device 22. The mobile device 20 can be, for example, a mobile telephone, a tablet PC, a wearable or the like. In the example shown, the mobile device 20 is a mobile telephone which is equipped with the display device 22. The display device 22 can be a capacitive display device with which a user can perform inputs by touching the surface of the display device 22.

The mobile device 20 is equipped with a subscriber identity module 10 as shown in FIG. 1. The subscriber identity module 10 can be a fixed part of the mobile device in the form of an integrated subscriber identity module 10 or be part of the mobile device 20 as a changeable subscriber identity module 10. An integrated subscriber identity module is known also as an eUICC (embedded Universally Integrated Circuit Card). The changeable subscriber identity module 10 is also known under the term SIM card (Subscriber Identity Module).

The subscriber identity module 10 known in the prior art serves for identifying the user vis-à-vis the mobile network operator. In the subscriber identity module a processor 12 as well as a storage 14 are configured. The storage 14 can be divided into a volatile and a non-volatile storage, in particular the storage can be divided into a ROM region, a RAM region and an EEPROM region. The operating system as a rule is deposited in the ROM region. There, different properties can further be stored for different mobile network operators.

Further stored in the storage 14 is the IMSI (International Mobile Subscriber Identity). This serves the unambiguous identification of the user vis-à-vis the mobile network operator. For further details on the subscriber identity module 10 as well as on the IMSI, reference is made to the prior art which is hereby explicitly enclosed.

In dependence on the country which the subscriber identity module is supplied to, there are rules or restrictions which decree which functions the subscriber identity module 10 may make available in the corresponding country. The following functions are stated by way of example: cryptographic algorithms or key lengths for cryptographic algorithms, licenses for applications/data or accesses to these (e.g. media files, database accesses), access to applications (for example payment/banking applications). Correspondingly, according to a restriction e.g. the length of a key for a cryptographic algorithm could be shortened. Alternatively, the access to certain applications can be restricted or prohibited in dependence on the location.

The manufacturers of subscriber identity modules 10 thus face the problem that in dependence on the countries which a subscriber identity module is to be supplied to, a plurality of subscriber identity modules 10 must be kept available in dependence on the range of functions permissible in the respective countries.

This is where the present invention sets in. The subscriber identity module 10 according to the invention additionally has a location determining device 16. The location determining device 16 is configured to determine a location of the subscriber identity module (10). The location determining device 16 can determine the location, for example, by querying location data from a mobile radio cell which the subscriber identity module 10 is registered with, i.e. which the subscriber identity module 10 is communicating with, and with the help of this location data said device determines which country the mobile device 20 and therefore the subscriber identity module 10 are located in.

Alternatively the location determining device 16 can employ a position detection module (not shown). The position detection module can be integrated into the mobile device 20 and/or into the subscriber identity module 10. The position detection module is configured for the purpose of processing position data, in particular GPS and/or GLONASS data/information. With the help of these data or information, a location of the subscriber identity module 10 can be determined and therefore the country which the subscriber identity module is located in.

The location determining device 16 can have a device which can recognize a false location information. In this manner it possible to recognize tampering with the subscriber identity module 10 or the location determining device 16.

In dependence on the country which the subscriber identity module 10 is located in, certain functions of the subscriber identity module can, for example, be impermissible. The subscriber identity module 10 makes at least a part of the functions available in a restricted manner or not at all in dependence on the determined location, in particular the determined country.

For example, some countries require that a particularly strong encryption or a particularly weak encryption is used there for data transmitted with the subscriber identity module to 10. Alternatively, in dependence on the location, licenses for an application could operate only with a restricted range of functions or the application could be not available at all. For example, a payment application or a banking application can function only in certain countries. In this manner, it is advantageously possible to admit the access to a payment application and/or banking application only in “secure” countries. It is thereby possible that in the storage 14 of the subscriber identity module there is deposited which functions are permissible in a country (whitelist) or which functions are impermissible in a country (blacklist).

The range of functions permissible in a certain country can further also depend on the mobile network operator (MNO) which the subscriber identity module 10 has set up a connection with. In dependence on the mobile radio network or the mobile network operator which the subscriber identity module 10 is connected to, at least a part of the above-mentioned functions can be made available in a restricted manner or not at all.

According to the invention, an application is further provided, which is deposited in the storage 14 of the subscriber identity module 10, which carries out the check at which location the subscriber identity module 10 is located. In dependence on the determined location, the application can restrict a part of the functions or not make them available.

1-12. (canceled)

13. A subscriber identity module for employment in a mobile device, having:
a processor,
a storage,
a location determining device which is adapted to determine a location of the subscriber identity module,
wherein the subscriber identity module is adapted to make available a plurality of functions, wherein
the subscriber identity module makes at least a part of the functions available in a restricted manner or not at all in dependence on the determined location,
wherein the function is the functional range of an encryption algorithm and/or wherein the function is the access to data and/or applications.

14. The subscriber identity module according to claim 13, wherein the storage has a volatile storage area and a non-volatile storage area.

15. The subscriber identity module according to claim 13, wherein the location determining device is adapted to determine the location with the help of a mobile radio cell which the subscriber identity module is registered with.

16. The subscriber identity module according to claim 13, wherein the location determining device, for determining the location, is adapted to employ a position detection module, wherein the position detection module can be integrated into the mobile device and/or the subscriber identity module.

17. The subscriber identity module according to claim 16, wherein the position detection module is adapted to process GPS and/or GLONASS information.

18. The subscriber identity module according to claim 13, wherein the location comprises at least one information item as to the country the subscriber identity module is located in.

19. The subscriber identity module according to claim 13, wherein the subscriber identity module is a SIM card, an UICC and/or an eUICC.

20. The subscriber identity module according to claim 13, wherein the functions available in dependence on the determined location are stored in a whitelist.

21. The subscriber identity module according to claim 13, wherein the functions not available in dependence on the determined location are stored in a blacklist.

22. The subscriber identity module according to claim 13, wherein the function is the key length of a cryptographic algorithm, in particular a signature and/or hash algorithm.

23. The subscriber identity module according to claim 13, wherein the subscriber identity module makes at least a part of the functions available in a restricted manner or not at all, in dependence on the mobile network operator to which the subscriber identity module is connected.

24. An application executable on a subscriber identity module, which is adapted to make available in dependence on the determined location at least a part of the functions in a restricted manner or not at all, wherein the application is adapted to determine the location of the subscriber identity module while employing a location determining device.
